(19) United States
(12) Patent Application Publication
(10) Pub. No.: US 2024/0015530 A1
(43) Pub. Date: Jan. 11, 2024

(54) Routing in Integrated Access and Backhaul Communication

(71) Applicant: Nokia Technologies Oy, Espoo (FI)

(72) Inventors: Matti LAITILA, Oulu (FI); Xiang Xu, Nanjing, Jiangsu (CN); Henri KOSKINEN, Espoo (FI); Ilkka KESKITALO, Oulu (FI); Esa MALKAMAKI, Espoo (FI)

(21) Appl. No.: 18/035,003

(22) PCT Filed: Nov. 4, 2020
(86) PCT No.: PCT/CN2020/126600

§ 371 Date: May 2, 2023

(51) Int. Cl. H04W 24/02

(52) U.S. Cl. CPC H04W 24/02

(57) ABSTRACT

Embodiments of the present disclosure relate to routing in integrated access and backhaul (IAB) communication. According to embodiments of the present disclosure, two or more IAB donors share topology information for inter IAB network routing. The IAB donors allocate addresses to IAB nodes with dual connectivity based on the topology information. In this way, it avoids address collisions when routing in the inter IAB networks.

### FIELD

Embodiments of the present disclosure generally relate to the field of communications and in particular, to a method, device, apparatus and computer readable storage medium for routing in integrated access and backhaul (IAB) communication.

### BACKGROUND

IAB has been introduced in Release 16 (Rel-16) of 3GPP specifications as a key enabler for fast and cost-efficient deployments. IAB nodes use the same or different spectrum and air interface for access and backhaul, creating a hierarchical wireless multi-hop (multiple backhaul links) network between sites. The hops eventually terminate at an IAB donor that is connected by means of a conventional fixed backhaul to the core network. An IAB node contains a mobile termination (MT) part that acts as user equipment (UE) towards its parent distributed unit (DU), and a DU part that acts as a base station towards the mobile terminal and/or the child IAB node. An IAB donor contains a central unit (CU) part and a DU part. An IAB DU can provide one or more cells to serve UEs. In some cases, one IAB node may connect with more than one IAB donor. Therefore, traffic may be routed among IAB donors.

### SUMMARY

Generally, embodiments of the present disclosure relate to a method for routing in integrated access and backhaul (IAB) communication and the corresponding communication devices.

In a first aspect, there is provided a first device. The first device comprises at least one processor; and at least one memory including computer program codes; the at least one memory and the computer program codes are configured to, with the at least one processor, cause the first device to receive, from a second device, a route request at least indicating: a third device connected with the first and the second devices, and a first address of the third device allocated by the second device. The first device is also caused to transmit a route response to the second device, the route response at least indicating: a second address of the third device allocated by the first device, a fourth device which is a next hop of the third device in communication with the first device, and an identifier of a next-hop link between the third device and the fourth device. The first device is further caused to transmit, to the fourth device, routing information indicating a mapping between the first and second addresses.

In a second aspect, there is provided a second device. The second device comprises at least one processor; and at least one memory including computer program codes; the at least one memory and the computer program codes are configured to, with the at least one processor, cause the second device to transmit, to a first device, route request at least indicating: a third device connected with the first and the second devices, and a first address of the third device allocated by the second device. The first device is further caused to receive a route response from the first device, the route response at least indicating: a second address of the third device allocated by the first device, a fourth device which is a next hop of the third device in communication with the first device, and an identifier of a next-hop link between the third device and the fourth device.

In a third aspect, there is provided a fourth device. The fourth device comprises at least one processor; and at least one memory including computer program codes; the at least one memory and the computer program codes are configured to, with the at least one processor, cause the fourth device to receive, from a first device, routing information indicating a mapping between a first address of a third device allocated by a second device and a second address of the third device allocated by the first device, the third device connecting with the first and the second devices and the fourth device being a next hop of the third device in connecting with the first device. The fourth device is further caused to transmit a traffic to the third device based on the routing information.

In a fourth aspect, there is provided a method. The method comprises receiving, at a first device and from a second device, a route request at least indicating: a third device connected with the first and the second devices, and a first address of the third device allocated by the second device. The method also comprises transmitting a route response to the second device, the route response at least indicating: a second address of the third device allocated by the first device, a fourth device which is a next hop of the third device in communication with the first device, and an identifier of a next-hop link between the third device and the fourth device. The method further comprises transmitting, to the fourth device, routing information indicating a mapping between the first and second addresses.

In a fifth aspect, there is provided a method. The method comprises transmitting, at a second device and to a first device, a route request at least indicating: a third device connected with the first and second devices, and a first address of the third device allocated by the second device. The method also comprises receiving a route response from the first device, the route response at least indicating: a second address of the third device allocated by the first device, a fourth device which is a next hop of the third device in communication with the first device, and an identifier of a next-hop link between the third device and the fourth device.

In a sixth aspect, there is provided a method. The method comprises receiving, at a fourth device and from a first device, routing information indicating a mapping between a first address of a third device allocated by a second device and a second address of the third device allocated by the first device, the third device connecting with the first and the second devices and the fourth device being a next hop of the third device in connecting with the first device. The method also transmitting a traffic to the third device based on the routing information.

In a seventh aspect, there is provided an apparatus. The apparatus comprises means for receiving, at a first device and from a second device, a route request at least indicating: a third device connected with the first and the second devices, and a first address of the third device allocated by the second device. The apparatus also comprises means for transmitting a route response to the second device, the route response at least indicating: a second address of the third device allocated by the first device, a fourth device which is a next hop of the third device in communication with the first device, and an identifier of a next-hop link between the third device and the fourth device. The apparatus further comprises means for transmitting, to the fourth device, routing information indicating a mapping between the first and second addresses.

In an eighth aspect, there is provided an apparatus. The apparatus comprises means for transmitting, at a second device and to a first device, a route request at least indicating: a third device connected with the first and second devices, and a first address of the third device allocated by the second device. The apparatus also comprises means for receiving a route response from the first device, the route response at least indicating: a second address of the third device allocated by the first device, a fourth device which is a next hop of the third device in communication with the first device, and an identifier of a next-hop link between the third device and the fourth device.

In a ninth aspect, there is provided an apparatus. The apparatus comprises means for receiving, at a fourth device and from a first device, routing information indicating a mapping between a first address of a third device allocated by a second device and a second address of the third device allocated by the first device, the third device connecting with the first and the second devices and the fourth device being a next hop of the third device in connecting with the first device. The apparatus further comprises means for transmitting a traffic to the third device based on the routing information.

In a tenth aspect, there is provided a non-transitory computer readable medium comprising program instructions for causing an apparatus to perform at least the method according to any one of the above fourth to sixth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a block diagram of a system for IAB network architecture;

FIG. 2 illustrates a schematic diagram of protocol stacks for IAB backhauling inside radio access network (RAN);

FIG. 3 illustrates a schematic diagram of protocol stacks for IAB backhauling from end-to-end view;

FIG. 4 illustrates a schematic diagram of a communication system according to embodiments of the present disclosure;

FIG. 5 illustrates a schematic diagram of interactions among devices according to embodiments of the present disclosure;

FIG. 6A illustrates a schematic diagram of downlink routing according to embodiments of the present disclosure;

FIG. 6B illustrates a schematic diagram of uplink routing according to embodiments of the present disclosure;

FIG. 7 illustrates a flow chart of a method implemented at a network device according to embodiments of the present disclosure;

FIG. 8 illustrates a flow chart of a method implemented at a device according to embodiments of the present disclosure;

FIG. 9 illustrates a flow chart of a method implemented at a device according to embodiments of the present disclosure;

FIG. 10 illustrates a schematic diagram of a device according to embodiments of the present disclosure; and

FIG. 11 shows an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a user equipment and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a user equipment accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology. The network device may refer to a gNB distributed unit (gNB-DU) or a gNB centralized unit (gNB-CU) or an Integrated Access and Backhaul node (IAB-node) or an IAB-node DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Example embodiments of the present disclosure are directed to a radio access network with wireless backhaul of the access points. The backhaul can be multi-hop or meshed. An important application of embodiments of the present disclosure is for IAB communication in a 3GPP IAB network with terminal devices, IAB nodes and wired IAB donor nodes. In the following, embodiments of the present disclosure will be described with reference to the 3GPP IAB network. It is to be understood that embodiments of the present disclosure may also be applied to any other network with wireless backhaul.

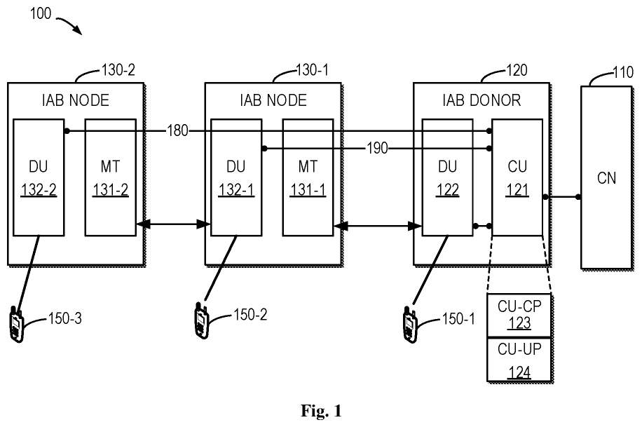

FIG. 1 illustrates a block diagram of a system 100 for IAB communication. As shown in FIG. 1, the system 100 comprises a core network (CN) 110, an IAB donor 120, IAB nodes 130-1 and 130-2 (collectively referred to as “IAB nodes 130” or individually referred to as “IAB node 130”), and terminal devices 150-1, 150-2 and 150-3 (collectively referred to as “terminal devices 150” or individually referred to as “terminal device 150”). As used herein, the terms “IAB node” and “IAB device” can be used interchangeably. The terms “IAB donor node”, “IAB donor” and “IAB donor device” can be used interchangeably.

In the architecture as shown in FIG. 1, the CN interfaces are terminated at the IAB donor 120 and therefore the relaying is only radio access network (RAN) functionality. The architecture leverages a split gNB architecture for the CU and DU so that the CU functions are at the IAB donor 120 and the DU function is at the IAB donor DU 122 or at the IAB node 130. For the connection setup and communication with the parent node (which can be another IAB node or the IAB donor), the IAB node 130 hosts the MT function corresponding to UE operation or a part of the UE operation.

The IAB donor 120 may comprise a CU 121 (also referred to as “IAB donor CU 121”) and a DU 122 (also referred to as “IAB donor DU 122”). It is to be understood that the CU 121 and DU 122 may be implemented in the same device, or in different devices. The CU 121 may further comprise a CU-Control Plane (CU-CP) 123, and one or more CU-User Plane (CU-UP) 124. It is to be understood that the CU-CP 123 and CU-UP 124 may be implemented in the same device, or in different devices. The IAB node 130-1 may comprise a MT part 131-1 and a DU 132-1. The IAB node 130-2 may comprise a MT part 131-2 and a DU 132-2. The MT parts 131-1 and 131-2 are also collectively referred to as “IAB MTs 131” or individually referred to as “IAB MT 131”. The DUs 132-1 and 132-2 are also collectively referred to as “IAB DUs 132” or individually referred to as “IAB DU 132”.

The IAB donor DU 122 or each IAB DU 132 can provide one or more cells to serve terminal devices and/or one or more IAB-MTs 131. For example, as shown in FIG. 1, the IAB donor DU 122 serves the terminal device 150-1, the IAB DU 132-1 serves the terminal device 150-2 and the IAB DU 132-2 serves the terminal device 150-3.

The IAB MT 131 of an IAB node 130 may act as a UE towards its parent node. For example, the IAB MT 131-1 may act as a UE towards the IAB donor 120 (i.e., the IAB donor DU 122) and the IAB MT 131-2 may act as a UE towards the IAB node 130-1 (i.e., the IAB DU 132-1). On the child links, the IAB DU 132 of an IAB node 130 may act as a network device (such as, gNB) towards its next-hop IAB node. For example, the IAB donor DU 122 may act as a gNB towards the IAB node 130-1 and the IAB DU 132-1 may act as a gNB towards the IAB node 130-2. On the access links, the IAB donor 120 and the IAB nodes 130 may act as normal network devices, providing radio interfaces for the terminal devices 150 in their coverage areas.

BH radio link control (RLC) channel(s) can be set up between the IAB MT 131 and a DU of the parent node and an adaptation layer called a Backhaul Adaptation Protocol (BAP) is agreed to be on top of a RLC layer. The IAB DU 132 connects to the IAB donor CU 121 with an F1 interface which supports IAB functions. For example, the IAB DU 132-1 connects to the IAB donor CU 121 via the F1 interface 190 and the IAB DU 132-2 connects to the IAB donor CU 121 via the F1 interface 180. The F1 interface may comprise a F1-C interface and a F1-U interface. The IAB DU 132 connects to the IAB Donor CU-CP 123 via the F1-C interface, and the IAB DU 132 connects to the IAB Donor CU-UP 124 via the F1-U interface.

The F1 interface traffic includes the traffic of the F1-U interface (also referred to as “F1-U traffic”) and the traffic of the F1-C interface (also referred to as “F1-C traffic”). The F1 interface traffic is transported on top of the adaptation layer. The IAB thus implements L2 relaying. To enable the downlink (DL) F1 traffic routed to the serving IAB donor DU 122 for the IAB node 130, the IAB node 130 is assigned with an Internet Protocol (IP) address(s) (e.g., outer IP address when IPSec tunnel is enabled) that is anchored in the IAB donor DU 122. When the IAB donor CU 121 sends the DL F1 traffic to the IAB node 130, the F1 traffic is routed to the IAB donor DU 122 based on the IP address. The IAB donor DU 122 maps the DL F1 traffic to a related BH RLC channel based on a configuration that is previously configured by the IAB donor CU 121. The configuration includes the differentiated services code point (DSCP) and/or Internet Protocol Version 6(IPv6) Flow Label and/or IP address in order to identify the DL F traffic, as well as the related BH RLC channel information. This requires that the IAB donor CU 121 (e.g., donor CU-CP or donor CU-UP) uses specific DSCP and/or IPv6 Flow Label and/or IP address in order to support the traffic mapping in the IAB donor DU 122.

Moreover, during topology adaptation, the serving IAB donor DU for an IAB node 130 may be changed from a source IAB donor DU to a target IAB donor DU. Accordingly, the IAB node 130 may get a new IP address(s) that is anchored in the target IAB donor DU.

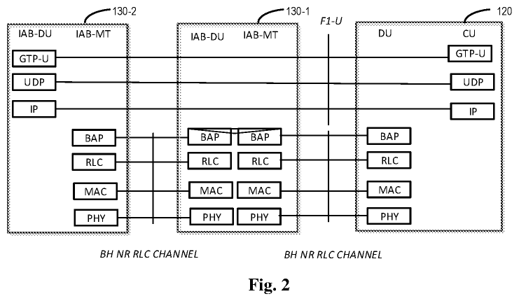

FIG. 2 illustrates a schematic diagram of protocol stacks for IAB backhauling inside RAN with CU-DU split. The IAB-node 130-2 hosts a Mobile Termination (MT) part 131-2 which comprises a General Packet Radio Service (GPRS) Tunneling protocol user plane (GTP-U) layer, a user datagram protocol (UDP) layer and an internet protocol (IP) layer. The IAB-node 130-2 also hosts a Distributed Unit (DU) part 132-2 which comprises a backhaul adaptation protocol (BAP) layer, a radio link control (RLC) layer, a medium access control (MAC) layer and a physical (PHY) layer. The MT part 131-2 has UE functionality and connects to the parent node DU. The parent node can be either IAB-donor or another IAB-node 130-1. Backhaul NR RLC channel(s) are setup between the MT part 131-2/131-1 and the parent nodes DU part 132-2/132-1 and adaptation layer called Backhaul Adaptation Protocol (BAP) is agreed to be on top of the RLC layer. The DU part of IAB-node 130-2 connects to CU 121 of the IAB-donor 120 with F1-U interface which is enhanced to support IAB functions. F1-U packets (GTP-U/UDP/IP for user plane (UP) and FlAP/SCTP/IP for control plane (CP)) are transported on top of the adaptation layer. IAB thus implements L2 relaying. An IAB node represents a co-located resource providing NR access coverage and backhauling over the air interface. As such, an IAB node may take on both the personality of UE (MT part) for transferring backhaul traffic or that of gNB (or gNB-DU) serving connected UEs and forwarding backhaul traffic to the next hop.

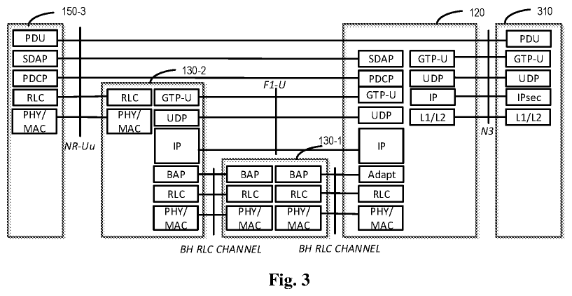

FIG. 3 a schematic diagram of protocol stacks for IAB backhauling from end-to-end view. As shown in FIG. 3, an interface between the IAB-donor 120 and a user plane function (UPF) 310 may be called “N3.” An interface between the terminal device 150-3 and the IAB node 130-2, the OBA donor 120 and the UPF 310 may be called “NR-Uu.”

As mentioned above, a F1-U connection may established between the IAB-donor CU and the IAB-DU. The BAP layer has peer entities in the IAB-nodes having BH link established starting from IAB-donor DU until the access IAB-node where the BH link should reach. Routing in BAP may be based on routing identity (ID) and related routing table configured by the donor-CU. Routing-ID may comprise destination BAP address and a path ID. The configured routing table may indicate a next-hop BAP node address where the BH data shall be forwarded. A mapping of BH data (bearers) to BH link RLC channels may be also configured by the donor-CU. The mapping may be 1:1 or N:1 mapping, where in the former case each bearer has its own RLC channel enabling the use of advanced/optimized scheduling methods. In N:1 mapping multiple BH bearers may be aggregated in a single RLC channel. The aggregation can be, for example, based on quality of service (QoS) class.

According to conventional technologies, a size of the BAP address may be 10 bits and the BAP address is defined to be IAB network specific, in other words, donor specific. IAB-donors may allocate the BAP addresses within their network.

For seamless BH change and/or to provide redundancy, inter-donor dual connectivity (DC) can be configured. Rel.16 supports only intra-donor DC but RAN3 has a Rel.17 study item on topological redundancy and RAN3 #109-e meeting agreed in “analyze the following scenarios for inter-Donor Topology Redundancy, with the principle that an IAB-DU only have F1 interface with one Donor-CU: the IAB is multi-connected with 2 Donors and the IAB's parent/ancestor node is multi-connected with 2 Donors.”

One issue to consider in the inter-donor DC is the BAP addresses and how they should be handled in a DC scenario. IAB-donors are allocating the addresses within the topologies they are controlling. If the IAB donors are independently configuring the addresses, there can be address collisions affecting the DC configuration and the inter IAB network routing.

In order to solve at least part of the above problems, solutions on routing in IAB communications are proposed. According to embodiments of the present disclosure, two or more IAB donors share topology information for inter IAB network routing. The IAB donors allocate addresses to IAB nodes with dual connectivity based on the topology information. In this way, it avoids address collisions when routing in the inter IAB networks.

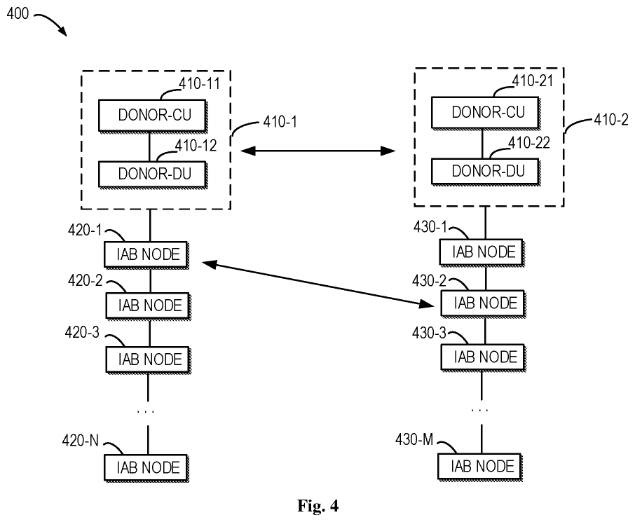

FIG. 4 shows an example IAB system 400 in which example embodiments of the present disclosure can be implemented. The IAB system 400 includes an IAB donor 410-1 and IAB nodes 420-1, 420-2, 420-3, . . . , 420-N (where N is a suitable integer number) underneath the IAB donor 410-1. The IAB nodes AB nodes 420-1, 420-2, 420-3, . . . , 420-N may be collectively referred to as IAB node 420. The IAB system also comprises an IAB donor 410-2 and IAB nodes 430-1, 430-2, 430-3, . . . , 420-M (where M is a suitable integer number) underneath the IAB donor 410-20. It should be noted that embodiments of the present disclosure can be implemented in any suitable systems. Only for the purpose of illustrations, embodiments of the present disclosure are described to be implemented in the IAB system. Only for the purpose of illustrations, a first device may be referred to as the IAB donor 410-1 hereinafter and a second device may be referred to as the IAB donor 410-2 hereinafter. A third device may be any suitable IAB node beneath the IAB donor 410-2. Only as an example, the third device may be referred to as the IAB node 430-2 hereinafter. A fourth device may be any suitable IAB node beneath the IAB donor 410-1. Only as an example, the fourth device may be referred to as the IAB node 420-1 hereinafter. It should be noted that the fourth device may not directly connect to the first device. The first device and the second device may be interchangeable.

The IAB donors 410-1 and 420-2 may be implemented as gNBs that terminate wireless backhaul radio interface from one or more IAB nodes. The IAB donors 410-1 and 420-2 have wired/fiber connectivity with a core network. The IAB donor 410-1 may include a central unit (CU) 410-11 and one or more DUs. The IAB donor 410-2 may include a CU 410-21 and one or more DUs. FIG. 4 shows that the IAB donor 410-1 includes a DU 410-12 and the IAB donor 410-2 includes a DU 410-22 by way of example. Hereinafter, the CU of the IAB donor is also referred to as Donor-CU or donor central unit; and the DU of the IAB donor is also referred to as Donor-DU or donor distributed unit.

A CU (such as Donor-CU or CU of an IAB node) may be a logical node which may include the functions (for example, gNB functions) such as transfer of user data, mobility control, radio access network sharing, positioning, session management etc., except those functions allocated exclusively to DUs. The CU may control the operation of the DUs over a front-haul (F1) interface. A DU is a logical node which may include a subset of the functions (for example, gNB functions), depending on the functional split option. The operations of the DUs may be controlled by the CU.

It is to be understood that the number of IAB nodes and terminal devices connected to the IAB nodes is only for the purpose of illustration without suggesting any limitations. The IAB system may include any suitable number of IAB nodes and terminal devices adapted for implementing example embodiments of the present disclosure.

It is to be understood that the numbers of CU, DU and the IAB nodes are only for the purpose of illustration without suggesting any limitations. The system 400 may include any suitable number of IAB nodes and IAB donors for implementing embodiments of the present disclosure.

Communications in the communication system 400 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

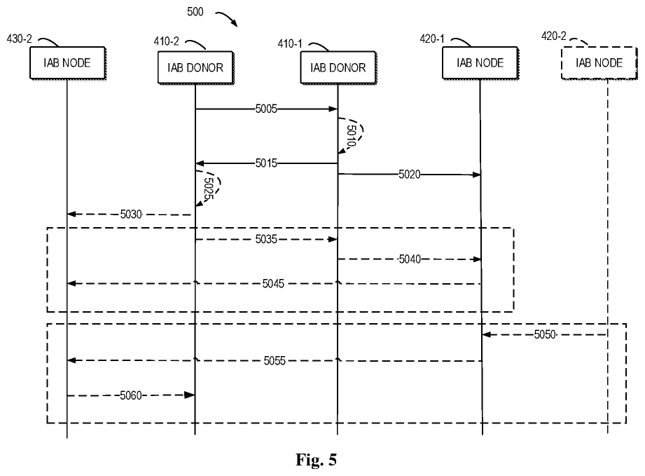

FIG. 5 illustrates a schematic diagram of interactions 500 in accordance with

embodiments of the present disclosure. The interactions 500 may be implemented at any suitable devices. Only for the purpose of illustrations, the interactions 500 are described to be implemented at the IAB donor 410-1, the IAB donor 410-2, the IAB node 420-1 and the IAB node 430-2. In some embodiments, the interactions 500 may also involve the IAB node 420-2. It should be noted that embodiments of the present disclosure can be implemented among any suitable devices.

The IAB donor 410-2 transmits 5005 a route request to the IAB donor 410-1. The route request indicates the IAB node 430-2 which connects with the IAB donor 410-2 and the IAB donor 410-1. The route request also indicates an address of the IAB node 430-2 allocated by the IAB donor 410-2, which is referred to as “a first address” hereinafter.

Only for the purpose of illustrations, the address of the IAB node 430-2 allocated by the IAB donor 410-2 may be “2.” In some embodiments, the route request may further indicate a set of devices and the IAB node 430-2 may be an intermediate node between the IAB donor 410-2 and the set of devices. The route request may also indicate a set of address of the set of devices allocated by the IAB donor 410-2. For example, the IAB node 430-2 may comprise one or more child node (for example, the IAB node 430-3). In this situation, the route request may indicate the IAB node 430-3 and an address of the IAB node 430-3 allocated by the IAB donor 410-2, for example “3.” Alternatively or in addition, the route request may comprise an initial address of the IAB donor 410-2. In other words, the route request may comprise the initial address of donor DU 410-22 allocated by the donor CU 410-21.

Alternatively or in addition, the route request may comprise an indication which is a next hop (for example, the IAB node 430-2) for a peer node in a network of the IAB donor 410-1. In other embodiments, the route request may comprise one or more path identities. QoS information about traffic routed through the IAB donor 410-1 may also be included in the route request. In some embodiments, the route request may comprise a RLC BH channel for the IAB node 430-2. The route request may also indicate IP flow information about traffic routed through the IAB donor 410-1. The IP flow information may be used for the IAB donor 410-1 to perform routing and bearer mapping.

The IAB donor 410-1 may determine whether the address of the IAB node 430-2 allocated by the IAB donor 410-2 is same as an existing address allocated by the IAB donor 410-1. If the address of the IAB node 430-2 allocated by the IAB donor 410-2 is the same as the existing address, the IAB donor 410-1 may allocate 5010 an address to the IAB node 430-2 which is referred to as “a second address” used hereinafter. The second address may be different from any existing addresses allocated by the IAB donor 410-1. For example, the route request indicates the first address is “2” and the existing addressed allocated by the IAB donor 410-1 may comprise “1”, “2” and “3”, the IAB donor 410-1 may allocate the second address “4” to the IAB node 430-2. In other embodiments, if the route request may also indicate that the address of the IAB node 430-3 allocated by the IAB donor 410-2 is “3”, the IAB donor 410-1 may allocate the address “5” to the IAB node 430-3. The addressed allocated to the IAB node 430-2 may be regarded as a virtual address.

The IAB donor 410-1 transmits 5015 a route response to the IAB donor 410-2. The route response indicates the second address of the IAB node 430-2 allocated by the IAB donor 410-1. The route response also indicates the IAB node 420-1 which is a next hop of the IAB node 430-2 in communication with the IAB donor 410-1. The route response may further indicate an identifier of a next-hop link between the IAB node 430-2 and the IAB node 420-1. In addition, the route response may indicate an address of the IAB node 420-1 allocated by the IAB donor 410-1 which is referred to as “a third address” hereinafter. The route response may also indicate a set of address of the set of devices allocated by the IAB donor 410-1. For example, the IAB node 420-1 may comprise one or more child node (for example, the IAB node 420-2). In this situation, the route response may indicate the IAB node 420-2 and an address of the IAB node 420-2 allocated by the IAB donor 410-2, for example “2.” In this way, it avoids address collisions between the IAB donors 410-1 and 410-2 without address coordination between the IAB donors 410-1 and 410-2.

The IAB donor 410-1 transmits 5020 routing information to the IAB node 420-1. The routing information indicates a mapping between the address of the IAB node 430-2 allocated by the IAB donor 410-2 (i.e., the first address) and the address of the IAB node 430-2 allocated by the IAB donor 410-1 (i.e., the second address).

In some embodiments, the IAB donor 410-2 may determine whether the address of the IAB node 420-1 allocated by the IAB donor 410-1 (i.e., the third address) is same as an existing address allocated by the IAB donor 410-2. If the address of the IAB node 420-1 allocated by the IAB donor 410-1 is the same as the existing address, the IAB donor 410-2 may allocate 5025 an address to the IAB donor 420-1 which is referred to as “a fourth address” used hereinafter. The fourth address may be different from any existing addresses allocated by the IAB donor 410-2. For example, the route response the third address is “1” and the existing addressed allocated by the IAB donor 410-1 may comprise “1”, “2” and “3”, the IAB donor 410-2 may allocate the fourth address “4” to the IAB node 420-1. In some embodiments, the route response may further indicate a set of devices and the IAB node 420-1 may be an intermediate node between the IAB donor 410-1 and the set of devices. In other embodiments, if the route response may also indicate that the address of the IAB node 420-2 allocated by the IAB donor 410-1 is “2”, the IAB donor 410-2 may allocate the address “5” to the IAB node 430-3.

In some embodiments, the IAB donor 410-2 may transmit 5030 routing information to the IAB node 430-2. The routing information may indicate a mapping between the address of the IAB node 420-1 allocated by the IAB donor 410-1 (i.e., the third address) and the address of the IAB node 420-1 allocated by the IAB donor 410-2 (i.e., the fourth address).

The IAB donor 410-2 may transmit traffic to the IAB node 430-2. In this situation, the traffic may indicate that the IAB node 430-2 is a destination of the traffic. For example, the traffic may comprise the first address of the IAB node 430-2. In some embodiments, the IAB donor 410-2 may transmit traffic to the IAB node 430-3. In this situation, the traffic may indicate that the IAB node 430-3 is a destination of the traffic. For example, the traffic may comprise the address of the IAB node 430-3 allocated by the IAB donor 410-2. The traffic may be transmitted from the IAB donor 410-2 to the IAB node 430-2 or the IAB node 430-3 via the network of the IAB donor 410-1 since the IAB node 430-2 connects with the IAB donor 410-1 and the IAB donor 410-2.

The IAB donor 410-2 may transmit 5035 the traffic to the IAB donor 410-1. A mentioned above, the traffic may indicate that the IAB node 430-2 is a destination of the traffic. In some embodiments, only as an example, the traffic may indicate that the IAB node 430-3 is a destination of the traffic and the IAB donor 410-1 may determine the routing information further indicating a mapping between the address of the IAB node 430-3 allocated by the IAB donor 410-2 and the address of the IAB node 430-3 allocated by the IAB donor 410-1.

In some embodiments, the IAB donor 410-1 may determine the second address of the IAB node 430-2 to be a next hop address for a backhaul link between the IAB node 430-2 and the IAB node 420-1. Alternatively or in addition, the IAB donor 410-1 may determine a backhaul channel for the traffic based on the flow information in the route request. In some embodiments, the backhaul channel may be determined based on an IP destination address, differentiated services code point (DSCP) bits and an IPv6 flow label of the traffic.

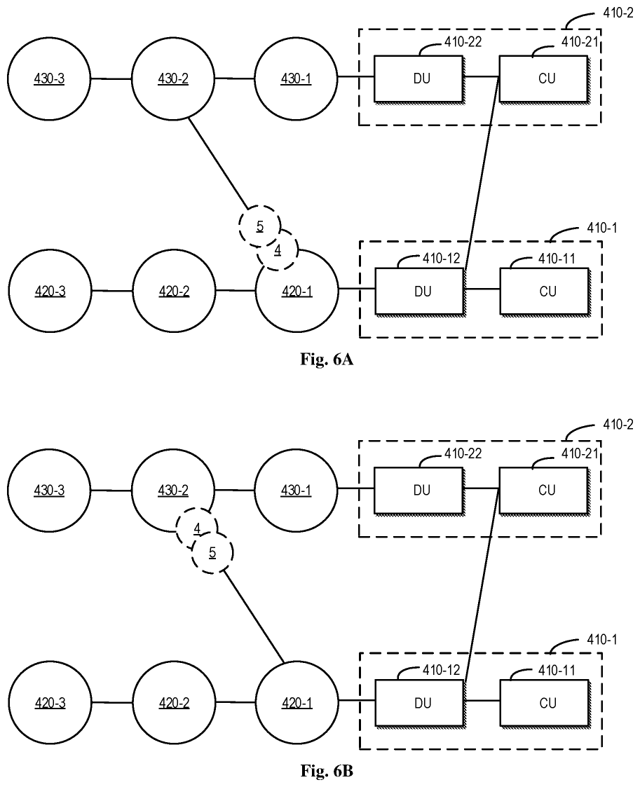

The IAB donor 410-1 may transmit 5040 the traffic to the IAB node 420-1. For example, the traffic may comprise the second address. The IAB node 420-1 may substitute the second address with the first address based on the routing information. The IAB node 420-1 may transmit 5045 the traffic to the IAB node 430-2 which comprises the first address. Details for downlink routing will be described with the reference to FIG. 6A later.

Alternatively, the IAB node 420-2 may transmit a further traffic to the IAB donor 410-1. The further traffic may be transmitted from the IAB node 420-2 to the IAB donor 410-1 via the network of the IAB donor 410-2 since the IAB node 420-1 connects with the IAB donors 410-1 and 410-2. The IAB node 420-2 may transmit 5050 the further traffic to the IAB node 420-1. The further traffic may comprise an address of the IAB donor 410-2 allocated by the IAB donor 410-1. The IAB node 420-1 may substitute the address of the IAB donor 410-2 allocated by the IAB donor 410-1 with an initial address of the IAB donor 410-2. The IAB node 420-1 may transmit 5055 the further traffic to the IAB node 430-2 which comprises the initial address of the IAB donor 410-2. The IAB node 430-2 may transmit 5060 the further traffic to the IAB donor 410-2. Details for uplink routing will be described with the reference to FIG. 6B later.

According to embodiments of the present disclosure, address collision can be avoided, without address coordination between IAB donors. BAP protocol remains intact and no additional protocol overhead to radio links may be added. Only modifications to operation of CU-CP and IAB node sending traffic to peer node are needed.

FIG. 6A illustrates a schematic diagram of downlink routing according to some embodiments of the present disclosure. As shown in FIG. 6A, only as an example, the address of the IAB node 430-2 allocated by the IAB donor 410-1 (in other words, by the CU 410-11 in the IAB donor 410-1) is “4” and the address of the IAB node 430-3 allocated by the IAB donor 410-1 is “5.” The address of the IAB node 430-2 allocated by the IAB donor 410-2 (in other words, allocated by the CU 410-21 in the IAB donor 410-2) is “2” and the address of the IAB node 430-3 allocated by the IAB donor 410-2 is “3.” Only for the purpose of illustrations, the downlink traffic may be transmitted from the IAB donor 410-2 to the IAB node 430-2 or 430-3. The CU 410-21 may transmit the traffic to the DU 410-12. The traffic may be transmitted to the IAB node 420-1 by the DU 410-12. Table 1 below shows example routing information configured by the IAB donor 410-1. It should be noted that Table 1 is only an example not limitation.

TABLE 1

| DESTINATION | NEXT HOP | NEW DESTINATION | |
|---|---|---|---|
| ADDRESS | ADDRESS | ADDRESS | LINK ID |
| 4 | 4 | 2 | W2-B1 link ID |
| 5 | 4 | 3 | W2-B1 link ID |

In some embodiment, if the traffic comprises the address “4”, the IAB node 420-1 may substitute the address “4” with the address “2” based on Table 1 and transmit the traffic to the IAB node 430-2. In other embodiments, if the traffic comprises the address “5”, the IAB node 420-1 may substitute the address “5” with the address “3” based on Table 1 and transmit the traffic to the IAB node 430-2. The IAB node 430-2 may further transmit the traffic to the IAB node 430-3.

FIG. 6B illustrates a schematic diagram of uplink routing according to some embodiments of the present disclosure. As shown in FIG. 6B, only as an example, the address of the IAB node 420-1 allocated by the IAB donor 410-1 (in other words, allocated by the CU 410-11 in the IAB donor 410-1) is “1” and the address of the DU 410-12 allocated by the CU 410-11 is “0.” The address of the IAB node 420-1 allocated by the IAB donor 410-2 (in other words, allocated by the CU 410-21 in the IAB donor 410-2) is “4” and the address of the DU 410-12 allocated by the IAB donor 410-2 (in other words, allocated by the CU 410-21 in the IAB donor 410-2) is “5.” Only for the purpose of illustrations, the uplink traffic may be transmitted from the IAB donor 430-3 to the IAB donor 410-2. In some embodiments, the uplink traffic may from other IAB node (for example, the IAB node 430-2) in the network of the IAB donor 410-2. The IAB node 430-3 may transmit the traffic to the IAB node 430-2. Table 2 below shows example routing information configured by the IAB donor 410-2. It should be noted that Table 2 is only an example not limitation.

TABLE 2

| DESTINATION | NEXT HOP | NEW DESTINATION | |
|---|---|---|---|
| ADDRESS | ADDRESS | ADDRESS | LINK ID |
| 5 | 4 | 0 | W2-B1 link ID |

In some embodiment, if the traffic comprises the address “5” which is the virtual address of the DU 410-12 allocated by the CU 410-21, the IAB node 430-2 may substitute the address “5” with the address “0” which is the initial address of the DU 410-12 allocated by the CU 410-11 based on Table 2 and transmit the traffic to the IAB node 420-1. The IAB node 420-1 may further transmit the traffic to the DU 410-12.

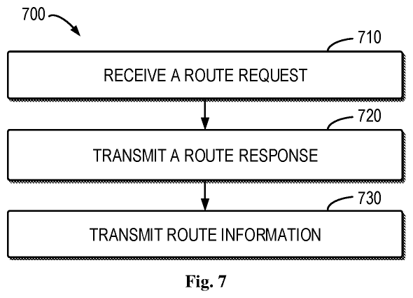

FIG. 7 is a flowchart of a method 700 implemented at an IAB donor in an IAB system according to some example embodiments of the present disclosure. The method can be implemented at any proper IAB donor. For the purpose of discussion, the method 700 is described to be implemented at the IAB donor 410-1 as shown in FIG. 4.

At block 710, the IAB donor 410-1 receives a route request from the IAB donor 410-2. The route request indicates the IAB node 430-2 which connects with the IAB donor 410-2 and the IAB donor 410-1. The route request also indicates an address of the IAB node 430-2 allocated by the IAB donor 410-2, which is referred to as “a first address” hereinafter. Only for the purpose of illustrations, the address of the IAB node 430-2 allocated by the IAB donor 410-2 may be “2.” In some embodiments, the route request may further indicate a set of devices and the IAB node 430-2 may be an intermediate node between the IAB donor 410-2 and the set of devices. The route request may also indicate a set of address of the set of devices allocated by the IAB donor 410-2. For example, the IAB node 430-2 may comprise one or more child node (for example, the IAB node 430-3). In this situation, the route request may indicate the IAB node 430-3 and an address of the IAB node 430-3 allocated by the IAB donor 410-2, for example “3.” Alternatively or in addition, the route request may comprise an initial address of the IAB donor 410-2. In other words, the route request may comprise the initial address of donor DU 410-22 allocated by the donor CU 410-21.

Alternatively or in addition, the route request may comprise an indication which is a next hop (for example, the IAB node 430-2) for a peer node in a network of the IAB donor 410-1. In other embodiments, the route request may comprise one or more path identities. QoS information about traffic routed through the IAB donor 410-1 may also be included in the route request. In some embodiments, the route request may comprise a RLC BH channel for the IAB node 430-2. The route request may also indicate IP flow information about traffic routed through the IAB donor 410-1. The IP flow information may be used for the IAB donor 410-1 to perform routing and bearer mapping.

In some embodiments, the IAB donor 410-1 may determine whether the address of the IAB node 430-2 allocated by the IAB donor 410-2 is same as an existing address allocated by the IAB donor 410-1. If the address of the IAB node 430-2 allocated by the IAB donor 410-2 is the same as the existing address, the IAB donor 410-1 may allocate an address to the IAB node 430-2 which is referred to as “a second address” used hereinafter. The second address may be different from any existing addresses allocated by the IAB donor 410-1. For example, the route request indicates the first address is “2” and the existing addressed allocated by the IAB donor 410-1 may comprise “1”, “2” and “3”, the IAB donor 410-1 may allocate the second address “4” to the IAB node 430-2. In other embodiments, if the route request may also indicate that the address of the IAB node 430-3 allocated by the IAB donor 410-2 is “3”, the IAB donor 410-1 may allocate the address “5” to the IAB node 430-3.

At block 720, the IAB donor 410-1 transmits a route response to the IAB donor 410-2. The route response indicates the second address of the IAB node 430-2 allocated by the IAB donor 410-1. The route response also indicates the IAB node 420-1 which is a next hop of the IAB node 430-2 in communication with the IAB donor 410-1. The route response may further indicate an identifier of a next-hop link between the IAB node 430-2 and the IAB node 420-1. In addition, the route response may indicate an address of the IAB node 420-1 allocated by the IAB donor 410-1 which is referred to as “a third address” hereinafter. The route response may also indicate a set of address of the set of devices allocated by the IAB donor 410-1. For example, the IAB node 420-1 may comprise one or more child node (for example, the IAB node 420-2). In this situation, the route response may indicate the IAB node 420-2 and an address of the IAB node 420-2 allocated by the IAB donor 410-2, for example “2.” In this way, it avoids address collisions between the IAB donors 410-1 and 410-2 without address coordination between the IAB donors 410-1 and 410-2.

At block 730, the IAB donor 410-1 transmits routing information to the IAB node 420-1. The routing information indicates a mapping between the address of the IAB node 430-2 allocated by the IAB donor 410-2 (i.e., the first address) and the address of the IAB node 430-2 allocated by the IAB donor 410-1 (i.e., the second address).

The IAB donor 410-1 may receive the traffic from the IAB donor 410-2. A mentioned above, the traffic may indicate that the IAB node 430-2 is a destination of the traffic. In some embodiments, only as an example, the traffic may indicate that the IAB node 430-3 is a destination of the traffic and the IAB donor 410-1 may determine the routing information further indicating a mapping between the address of the IAB node 430-3 allocated by the IAB donor 410-2 and the address of the IAB node 430-3 allocated by the IAB donor 410-1.

In some embodiments, the IAB donor 410-1 may determine the second address of the IAB node 430-2 to be a next hop address for a backhaul link between the IAB node 430-2 and the IAB node 420-1. Alternatively or in addition, the IAB donor 410-1 may determine a backhaul channel for the traffic based on the flow information in the route request. In some embodiments, the backhaul channel may be determined based on an IP destination address, differentiated services code point (DSCP) bits and an IPv6 flow label of the traffic.

In some embodiments, the IAB donor 410-1 may transmit the traffic to the IAB node 420-1. For example, the traffic may comprise the second address. Alternatively, the IAB node 420-2 may transmit a further traffic to the IAB donor 410-1. The further traffic may be transmitted from the IAB node 420-2 to the IAB donor 410-1 via the network of the IAB donor 410-2 since the IAB node 420-1 connects with the IAB donors 410-1 and 410-2. The further traffic may comprise an address of the IAB donor 410-2 allocated by the IAB donor 410-1.

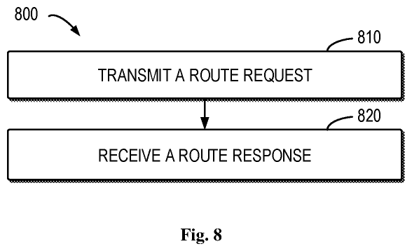

FIG. 8 is a flowchart of a method 800 implemented at an IAB donor in an IAB system according to some example embodiments of the present disclosure. The method can be implemented at any proper IAB donor. For the purpose of discussion, the method 800 is described to be implemented at the IAB donor 410-1 as shown in FIG. 4.

At block 810, the IAB donor 410-2 transmits a route request to the IAB donor 410-1. The route request indicates the IAB node 430-2 which connects with the IAB donor 410-2 and the IAB donor 410-1. The route request also indicates an address of the IAB node 430-2 allocated by the IAB donor 410-2, which is referred to as “a first address” hereinafter. Only for the purpose of illustrations, the address of the IAB node 430-2 allocated by the IAB donor 410-2 may be “2.” In some embodiments, the route request may further indicate a set of devices and the IAB node 430-2 may be an intermediate node between the IAB donor 410-2 and the set of devices. The route request may also indicate a set of address of the set of devices allocated by the IAB donor 410-2. For example, the IAB node 430-2 may comprise one or more child node (for example, the IAB node 430-3). In this situation, the route request may indicate the IAB node 430-3 and an address of the IAB node 430-3 allocated by the IAB donor 410-2, for example “3.” Alternatively or in addition, the route request may comprise an initial address of the IAB donor 410-2. In other words, the route request may comprise the initial address of donor DU 410-22 allocated by the donor CU 410-21.

Alternatively or in addition, the route request may comprise an indication which is a next hop (for example, the IAB node 430-2) for a peer node in a network of the IAB donor 410-1. In other embodiments, the route request may comprise one or more path identities. QoS information about traffic routed through the IAB donor 410-1 may also be included in the route request. In some embodiments, the route request may comprise a RLC BH channel for the IAB node 430-2. The route request may also indicate IP flow information about traffic routed through the IAB donor 410-1. The IP flow information may be used for the IAB donor 410-1 to perform routing and bearer mapping.

At block 820, the IAB donor 410-2 receives a route response from the IAB donor 410-1. The route response indicates the second address of the IAB node 430-2 allocated by the IAB donor 410-1. The route response also indicates the IAB node 420-1 which is a next hop of the IAB node 430-2 in communication with the IAB donor 410-1. The route response may further indicate an identifier of a next-hop link between the IAB node 430-2 and the IAB node 420-1. In addition, the route response may indicate an address of the IAB node 420-1 allocated by the IAB donor 410-1 which is referred to as “a third address” hereinafter. The route response may also indicate a set of address of the set of devices allocated by the IAB donor 410-1. For example, the IAB node 420-1 may comprise one or more child node (for example, the IAB node 420-2). In this situation, the route response may indicate the IAB node 420-2 and an address of the IAB node 420-2 allocated by the IAB donor 410-2, for example “2.” In this way, it avoids address collisions between the IAB donors 410-1 and 410-2 without address coordination between the IAB donors 410-1 and 410-2.

In some embodiments, the IAB donor 410-2 may determine whether the address of the IAB node 420-1 allocated by the IAB donor 410-1 (i.e., the third address) is same as an existing address allocated by the IAB donor 410-2. If the address of the IAB node 420-1 allocated by the IAB donor 410-1 is the same as the existing address, the IAB donor 410-2 may allocate 5025 an address to the IAB donor 420-1 which is referred to as “a fourth address” used hereinafter. The fourth address may be different from any existing addresses allocated by the IAB donor 410-2. For example, the route response the third address is “1” and the existing addressed allocated by the IAB donor 410-1 may comprise “1”, “2” and “3”, the IAB donor 410-2 may allocate the fourth address “4” to the IAB node 420-1. In some embodiments, the route response may further indicate a set of devices and the IAB node 420-1 may be an intermediate node between the IAB donor 410-1 and the set of devices. In other embodiments, if the route response may also indicate that the address of the IAB node 420-2 allocated by the IAB donor 410-1 is “2”, the IAB donor 410-2 may allocate the address “5” to the IAB node 430-3.

In some embodiments, the IAB donor 410-2 may transmit routing information to the IAB node 430-2. The routing information may indicate a mapping between the address of the IAB node 420-1 allocated by the IAB donor 410-1 (i.e., the third address) and the address of the IAB node 420-1 allocated by the IAB donor 410-2 (i.e., the fourth address).

The IAB donor 410-2 may transmit traffic to the IAB node 430-2. In this situation, the traffic may indicate that the IAB node 430-2 is a destination of the traffic. For example, the traffic may comprise the first address of the IAB node 430-2. In some embodiments, the IAB donor 410-2 may transmit the traffic to the IAB donor 410-1. A mentioned above, the traffic may indicate that the IAB node 430-2 is a destination of the traffic. In some embodiments, only as an example, the traffic may indicate that the IAB node 430-3 is a destination of the traffic and the IAB donor 410-1 may determine the routing information further indicating a mapping between the address of the IAB node 430-3 allocated by the IAB donor 410-2 and the address of the IAB node 430-3 allocated by the IAB donor 410-1.

Alternatively, the IAB node 420-2 may transmit a further traffic to the IAB donor 410-1. The further traffic may be transmitted from the IAB node 420-2 to the IAB donor 410-1 via the network of the IAB donor 410-2 since the IAB node 420-1 connects with the IAB donors 410-1 and 410-2. The IAB node 420-2 may transmit the further traffic to the IAB node 420-1. The further traffic may comprise an address of the IAB donor 410-2 allocated by the IAB donor 410-1.

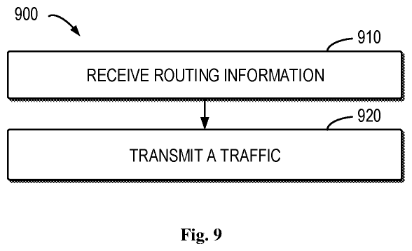

FIG. 9 is a flowchart of a method 900 implemented at an IAB node in an IAB system according to some example embodiments of the present disclosure. The method can be implemented at any proper IAB node. For the purpose of discussion, the method 900 is described to be implemented at the IAB node 420-1 as shown in FIG. 4.

At block 910, the IAB node 420-1 receives routing information from the IAB donor 410-1. The routing information indicates a mapping between the address of the IAB node 430-2 allocated by the IAB donor 410-2 (i.e., the first address) and the address of the IAB node 430-2 allocated by the IAB donor 410-1 (i.e., the second address).

At block 920, the IAB node 420-1 transmits traffic to the IAB node 430-2. In some embodiments, the IAB donor 410-1 may transmit the traffic to the IAB node 420-1. For example, the traffic may comprise the second address. The IAB node 420-1 may substitute the second address with the first address based on the routing information. The IAB node 420-1 may transmit the traffic to the IAB node 430-2 which comprises the first address.

In other embodiments, the IAB node 420-2 may transmit the further traffic to the IAB node 420-1. The further traffic may comprise an address of the IAB donor 410-2 allocated by the IAB donor 410-1. The IAB node 420-1 may substitute the address of the IAB donor 410-2 allocated by the IAB donor 410-1 with an initial address of the IAB donor 410-2. The IAB node 420-1 may transmit the further traffic to the IAB node 430-2 which comprises the initial address of the IAB donor 410-2.

In some embodiments, an apparatus for performing the method 700 (for example, the IAB donor 410-1) may comprise respective means for performing the corresponding steps in the method 700. These means may be implemented in any suitable manners. For example, it can be implemented by circuitry or software modules.

In some embodiments, the apparatus comprises means for receiving, at a first device and from a second device, a route request at least indicating: a third device connected with the first and the second devices, and a first address of the third device allocated by the second device; means for transmitting a route response to the second device, the route response at least indicating: a second address of the third device allocated by the first device, a fourth device which is a next hop of the third device in communication with the first device, and an identifier of a next-hop link between the third device and the fourth device; and means for transmitting, to the fourth device, routing information indicating a mapping between the first and second addresses.

In some embodiments, the apparatus further comprises means for receiving a first traffic from the second device, the first traffic indicating that the third device is a destination of the first traffic; and means for transmitting the first traffic to the fourth device.

In some embodiments, the route request further indicates at least one of the following: a path identity between the first device and the third device, a radio link control (RLC) backhaul (BH) channel for the third device, quality of service information about traffic routed through the first device, IP flow information about traffic routed through the first device, the third device being an intermediate node between the second device and the set of devices, a set of addresses of the set of devices allocated by the second device, or an initial address of the second device.

In some embodiments, the apparatus further comprises means for determining the second address to be a next hop address for a backhaul link between the third and fourth devices; means for receiving second traffic from the second device, the second traffic indicating that a device from the set of devices is a destination of the second traffic; means for determining the routing information further indicating: a mapping between a fourth address of the destination device allocated by the second device and a fifth address of the destination device allocated by the first device; means for transmitting the routing information to the fourth device; and means for transmitting the second traffic to the fourth device.

In some embodiments, the apparatus further comprises means for determining a backhaul channel for the first traffic or the second traffic based on IP flow information in the route request.

In some embodiments, the apparatus further comprises means for in accordance with a determination that the first address is an existing address allocated by the first device, allocating the second address to the third device, the second address is different from any existing addresses allocated by the first device.

In some embodiments, an apparatus for performing the method 800 (for example, the IAB donor 410-2) may comprise respective means for performing the corresponding steps in the method 800. These means may be implemented in any suitable manners. For example, it can be implemented by circuitry or software modules.

In some embodiments, the apparatus comprises means for transmitting, at a second device and to a first device, a route request at least indicating: a third device connected with the first and second devices, and a first address of the third device allocated by the second device; and means for receiving a route response from the first device, the route response at least indicating: a second address of the third device allocated by the first device, a fourth device which is a next hop of the third device in communication with the first device, and about traffic routed through the first device.

In some embodiments, the apparatus further comprises means for in accordance with a determination that of a third address of the fourth device allocated by the first device is same as an existing address allocated by the second device, allocating a sixth address to the fourth device, the sixth address being different from any existing addresses allocated by the second device; and means for transmitting, to the third device, routing information indicating a mapping between the third and sixth addresses.

In some embodiments, the route request further indicates at least one of the following: a path identity between the first device and the third device, a radio link control (RLC) backhaul (BH) channel for the third device, quality of service information about traffic routed through the first device, IP flow information about traffic routed through the first device, a set of devices, the third device being an intermediate node between the second device and the set of devices, a set of addresses of the set of devices allocated by the second device, or an initial address of the second device.

In some embodiments, the apparatus further comprises means for transmitting, to the first device, traffic indicating that the third device or one of the set of devices is a destination of the traffic.

In some embodiments, an apparatus for performing the method 900 (for example, the IAB node 420-1) may comprise respective means for performing the corresponding steps in the method 900. These means may be implemented in any suitable manners. For example, it can be implemented by circuitry or software modules.

In some embodiments, the apparatus comprises means for receiving, at a fourth device and from a first device, routing information indicating a mapping between a first address of a third device allocated by a second device and a second address of the third device allocated by the first device, the third device connecting with the first and the second devices and the fourth device being a next hop of the third device in connecting with the first device; and means for transmitting a traffic to the third device based on the routing information.

In some embodiments, the apparatus further comprises means for receiving, from the first device, the traffic comprising the second address; means for substituting the second address with the first address based on the routing information; and wherein the means for transmitting the traffic comprises: means for transmitting, to the third device, the traffic comprising initial address.

In some embodiments, the apparatus further comprises means for receiving, from a fifth device, the traffic comprising an address of the second device allocated by the first device , the fourth device being an intermediate node between the fifth and first devices; means for substituting the address of the second device allocated by the first device with an initial address of the second device; and wherein the means for transmitting the traffic comprises: means for transmitting, to the third device, the traffic comprising the first address.

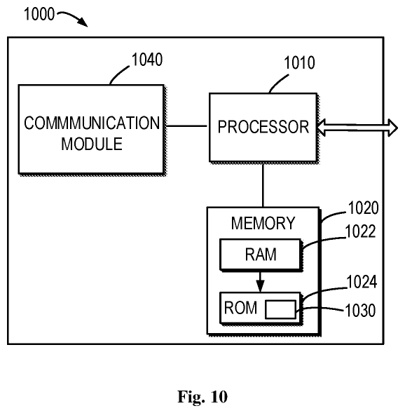

FIG. 10 is a simplified block diagram of a device 1000 that is suitable for implementing embodiments of the present disclosure. The device 1000 may be provided to implement the communication device, for example the IAB donor or the IAB node as shown in FIG. 4. As shown, the device 1000 includes one or more processors 1010, one or more memories 1020 coupled to the processor 1010, and one or more communication module (for example, transmitters and/or receivers (TX/RX)) 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program 1030 so that the device 1000 may perform any process of the disclosure as discussed with reference to FIGS. 5-9. The embodiments of the present disclosure may also be implemented by hardware or by a combination of software and hardware.

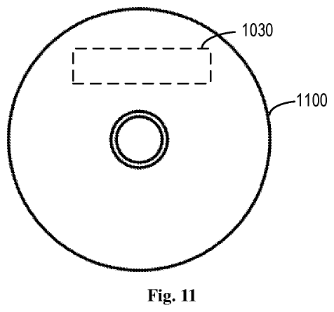

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 700 to 900 as described above with reference to FIGS. 7-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one non-transitory memory storing instructions that, when executed with the at least one processor, cause the first device to:
receive, from a second device, a route request at least indicating:
a third device connected with the first and the second devices, and
a first address of the third device allocated with the second device;
transmit a route response to the second device, the route response at least indicating:
a second address of the third device allocated with the first device,
a fourth device which is a next hop of the third device in communication with the first device, and
an identifier of a next-hop link between the third device and the fourth device; and
transmit, to the fourth device, routing information indicating a mapping between the first and second addresses.

2. The first device of claim 1, wherein the instructions, when executed with the at least one processor, cause the first device to:
receive a first traffic from the second device, the first traffic indicating that the third device is a destination of the first traffic; and
transmit the first traffic to the fourth device.

3. The first device of claim 1, wherein the route request further indicates at least one of the following:
a path identity between the first device and the third device,
a radio link control backhaul channel for the third device,
quality of service information about traffic routed through the first device,
internet protocol flow information about traffic routed through the first device,
a set of devices, the third device being an intermediate node between the second device and the set of devices,
a set of addresses of the set of devices allocated with the second device, or
an initial address of the second device.

4. The first device of claim 3, wherein the instructions, when executed with the at least one processor, cause the first device to:
determine the second address to be a next hop address for a backhaul link between the third and fourth devices;
receive second traffic from the second device, the second traffic indicating that a device from the set of devices is a destination of the second traffic;
determine the routing information further indicating: a mapping between a fourth address of the destination device allocated with the second device and a fifth address of the destination device allocated with the first device;
transmit the routing information to the fourth device; and
transmit the second traffic to the fourth device.

5. The first device of claim 2, wherein the instructions, when executed with the at least one processor, cause the first device to:
determine a backhaul channel for the first traffic or the second traffic based on internet protocol flow information in the route request.

6. The first device of claim 1, wherein the instructions, when executed with the at least one processor, cause the first device to:
in accordance with a determination that the first address is an existing address allocated with the first device, allocate the second address to the third device, the second address is different from existing addresses allocated with the first device.

7. The first device of claim 1, wherein the first device comprises a first network device, the second device comprises a second network device, the third device comprises a first integrated access backhaul node device, and the fourth device comprises a second integrated access backhaul node device.

8. A second device, comprising:
at least one processor; and
at least one non-transitory memory storing instructions that, when executed with the at least one processor, cause the second device to:
transmit, to a first device, a route request at least indicating:
a third device connected with the first and second devices, and
a first address of the third device allocated with the second device; and
receive a route response from the first device, the route response at least indicating:
a second address of the third device allocated with the first device,
a fourth device which is a next hop of the third device in communication with the first device, and
an identifier of a next-hop link between the third device and the fourth device.

9. The second device of claim 8, wherein the instructions, when executed with the at least one processor, cause the second device to:
in accordance with a determination that of a third address of the fourth device allocated with the first device is same as an existing address allocated with the second device, allocate a sixth address to the fourth device, the sixth address being different from existing addresses allocated with the second device; and
transmit, to the third device, routing information indicating a mapping between the third and sixth addresses.

10. The second device of claim 8, wherein the route request further indicates at least one of the following:
a path identity between the first device and the third device,
a radio link control backhaul channel for the third device,
quality of service information about traffic routed through the first device,
internet protocol flow information about traffic routed through the first device,
a set of devices, the third device being an intermediate node between the second device and the set of devices,
a set of addresses of the set of devices allocated with the second device, or
an initial address of the second device.

11. The second device of claim 8, wherein the instructions, when executed with the at least one processor, cause the second device to:
transmit, to the first device, traffic indicating that the third device or one of the set of devices is a destination of the traffic.

12. The second device of claim 8, wherein the first device comprises a first network device, the second device comprises a second network device, the third device comprises a first integrated access and backhaul node device, and the fourth device comprises a second integrated access and backhaul node device.

13. A fourth device, comprising:
at least one processor; and
at least one non-transitory memory storing instructions that, when executed with the at least one processor, cause the third device to:
receive, from a first device, routing information indicating a mapping between a first address of a third device allocated with a second device and a second address of the third device allocated with the first device, the third device connecting with the first and the second devices and the fourth device being a next hop of the third device in connecting with the first device; and
transmit a traffic to the third device based on the routing information.

14. The fourth device of claim 13, wherein the instructions, when executed with the at least one processor, cause the fourth device to:
receive, from the first device, the traffic comprising the second address; and
substitute the second address with the first address based on the routing information; and
wherein transmitting the traffic comprises:
transmitting, to the third device, the traffic comprising the first address.

15. The fourth device of claim 13, wherein the instructions, when executed with the at least one processor, cause the fourth device to:
receive, from a fifth device, the traffic comprising an address of the second device allocated with the first device, the fourth device being an intermediate node between the fifth and first devices; and
substitute the address of the second device allocated with the first device with an initial address of the second device; and
wherein transmitting the traffic comprises:
transmitting, to the third device, the traffic comprising the initial address.

16. The fourth device of claim 13, wherein the first device comprises a first network device, the second device comprises a second network device, the third device comprises a first integrated access and backhaul node device, and the fourth device comprises a second integrated access and backhaul node device.

17-34. (canceled)
